(19) United States
(12) Patent Application Publication
(10) Pub. No.: US 2003/0074436 A1
(43) Pub. Date: Apr. 17, 2003

(54) Management information base object model

(75) Inventor: Eric J. Gieseke, Lincoln, MA (US)

Correspondence Address: Fogg Slifer Polglaze Leffert & Jay, P.A., P.O. Box 581009, Minneapolis, MN, 55458-1009, US

(73) Assignee: ADC Broadband Access Systems Inc.

(21) Appl. No.: 10/178,964

(22) Filed: Jun. 25, 2002

Related U.S. Application Data
(60) Provisional application No. 60/327,064, filed on Oct. 4, 2001.

(51) Int. Cl. G06F 15/173

(52) U.S. Cl. 709/223

(57) ABSTRACT

A network device object model and method is detailed that manages configuration and tasking of attached hardware with efficient mapping of internal network device object instances to SNMP or RMON protocol MIBs of the network device. The network device object model and method utilizes an object oriented design and MIB implementation that allows the network device to get, and set SNMP and RMON configuration information to MIBs of the object oriented network device in an efficient manner.

### RELATED APPLICATION

This application claims priority to U.S. Provisional Patent Application Serial No. 60/327,064 filed Oct. 4, 2001 and titled “Management Information Base Object Model” which is commonly assigned and incorporated by reference herein.

### TECHNICAL FIELD

The present invention relates generally to network devices with management information bases (MIB) and in particular the present invention relates to MIB object models of network devices with object oriented design and components.

### BACKGROUND

Modern networks and network systems are typically constructed of multiple differing network devices, elements, or links, referred to collectively herein as network devices. These network devices can each have multiple configurations, settings, and polices depending on the specific task the network device has within the network or system. Additionally, the network devices are often of a general application type such that they require configuration to perform their purpose in the network or network system.

In configuring network devices in a network system, several protocols have come into common usage. Two of these protocols, simple network management protocol (SNMP), and remote monitoring (RMON), utilize MIBs to aid in their representation and manipulation of the managed device. A MIB is a tree structured information base representation of the network device being managed.

Network systems that are managed with a configuration protocol contain two primary elements: management facilities and “agents”. The management facility is the console, program, or other device that is coupled to the network system through which the network administrator performs network management functions. Agents are the entities that interface to the actual network device being managed, such as, bridges, hubs, routers or network servers, and are typically a functional part of the network device being managed. The agent, however, can be separate from the network device being managed, such as with a “proxying” SNMP capable network device that manages its own hardware and “proxies” for the management of one or more other network devices to the management facility.

SNMP and RMON are both open protocols utilized for network management applications. SNMP and RMON protocols are of a request-response type, and operate between a management facility and an agent to get and set network device variables. Requests in these protocols are typically initiated by the management facility. The agent, however, may be programmed to send asynchronous messages or “traps” to a management facility when a desired event occurs.

In SNMP or RMON management, the managed network devices contain managed “objects”. The managed objects might be hardware, configuration parameters, performance statistics, etc., that directly relate to the current operation of the device in question. These objects are arranged in a virtual information database, called a MIB. SNMP and RMON allow management facilities and agents to communicate for the purpose of accessing the MIB objects. Each network device agent must provide for mapping of its internal functions and data representations of the network device to the SNMP or RMON MIB(s) that are presented to the management facility. This mapping or forming of a MIB(s) by the agent of the network device to the network device's internal hardware, firmware, and software routines is a difficult and error prone process for each network device that is being designed.

In modern programming the use of object oriented design (OOD) and object oriented programming (OOP) is becoming more and more common. In OOP an object model with various object classes is defined for the intended application, such as a network device. The object model is intended to abstract the methods, data, and implementation specifics to obtain a more efficient and less error prone implementation. Object classes contain methods and attributes that enable them to provide their intended function in the object model. When an object is utilized in the intended application a copy, or “instance”, of the defined object class is created. The object instance is then operated upon by other object instances of the application to help attain the specified goal(s) of the application. When an object instance is no longer required, it is “destroyed” and the resources it used are freed for other purposes.

OOD abstraction of methods, data, and implementation specifics may leave object methods and attributes in a state that may not easily be mapped to the intended SNMP or RMON MIB(s). Additionally, this task is made more difficult by the creation and destruction of object instances in the application that require the mapping of multiple dynamic object instances to their intended MIB objects.

For the reasons stated above, and for other reasons stated below which will become apparent to those skilled in the art upon reading and understanding the present specification, there is a need in the art for an object model and method for conveniently mapping object methods and attributes to MIB(s) to allow managing of configurations in network devices in a managed network system.

### SUMMARY

The above-mentioned problems with conveniently mapping object methods and attributes to MIB(s) to allow managing of configurations in network devices in a managed network system are addressed by embodiments of the present invention and will be understood by reading and studying the following specification.

In one embodiment, an object model includes at least one first object, wherein the at least one first object is adapted to map at least one attribute or method of at least one second object to a management information base (MIB).

In another embodiment, a method of forming an object model for a network device includes representing device information, methods, and control values in at least one first object, and mapping the represented device information, methods, and control values in the at least one first object to a management information base (MIB) with at least one second object.

In yet another embodiment, a machine-usable medium has machine readable instructions stored thereon for execution by a processor to perform a method. The method includes acquiring network device information, methods, and control values, and mapping the acquired device information, methods, and control values to a management information base (MIB) with at least one object.

In a further embodiment, a network device includes a memory, a network interface, a processor coupled to the memory and the network interface, and an object model. The object model includes at least one first object, and one or more second objects, where the at least one first object is adapted to map at least one attribute or method of the one or more second objects to a management information base (MIB).

In yet a further embodiment, an object model for a network device includes a first set of objects, the first set of objects adapted to contain configuration information, methods, and data for the network device, and a second set of objects, wherein the second set of objects is adapted to represent the configuration information, methods, and data of the first set of objects in one or more management information base (MIB)s.

In another embodiment, a network device has a memory, a network interface, a computer-usable medium for storing computer readable instructions, and a processor coupled to the memory, the computer-usable medium, and a network interface, and an object model. The object model includes a first set of objects, where the first set of objects adapted to contain configuration information, methods, and data for the network device, and a second set of objects, wherein the second set of objects is adapted to represent the configuration information, methods, and data of the first set of objects in one or more management information base (MIB)s.

In yet another embodiment, a network device includes a memory, a network interface, a processor coupled to the memory and the network interface, a management information base (MIB), and an object model. The object model includes at least one first object, and at least one second object, where the at least one first object is adapted to map at least one attribute or method of the at least one second object to the management information base (MIB).

Other embodiments are described and claimed.

### BRIEF DESCRIPTION OF THE DRAWINGS

FIGS. 1A and 1B are simplified diagrams, of a network system with network devices.

FIG. 2 is a simplified diagram of MIB object tree.

FIG. 3 is a simplified diagram of an object model of an embodiment of the present invention.

FIG. 4 is a simplified diagram of another embodiment of the present invention.

FIG. 5 is a simplified diagram of another object model of an embodiment of the present invention.

### DETAILED DESCRIPTION

In the following detailed description, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention include network devices that utilize object oriented programming techniques to model and configure their hardware and internal configuration by expressing them in one or more MIBs. Embodiments of the present invention also include MIB objects that map from the attributes and methods of the internal objects of object oriented network devices to represented device MIBs. Such network devices communicate via a network management protocol such as SNMP or RMON and include, but are not limited to, hubs, switches, routers, configuration servers, provisioning servers, cable modems, etc.

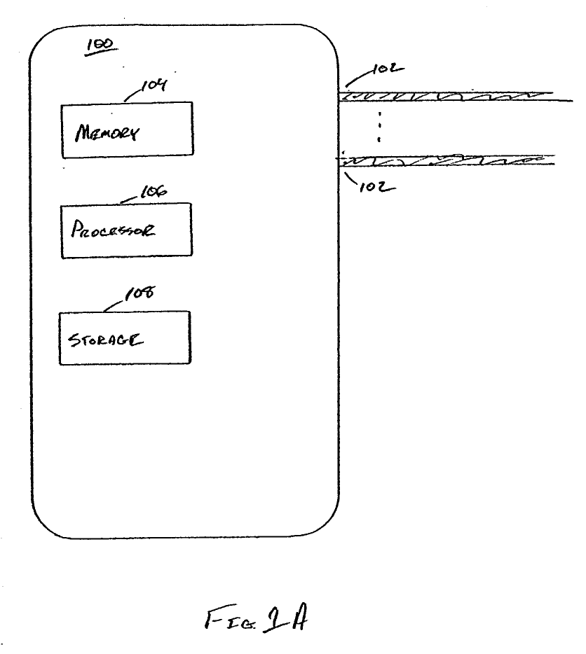

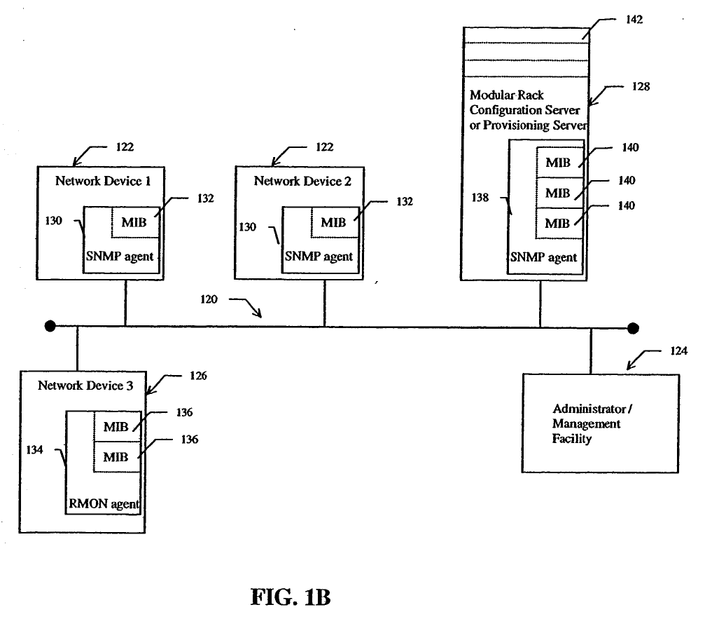

Network devices generally take the physical form of a network element in a managed network system, as shown in FIG. 1A. The network element 100 has in one embodiment one or more network interfaces 102, a memory 104, a processor 106, and a storage element 108 that is in one embodiment a computer readable media. Computer-readable media is defined for the purposes of this disclosure as a set of computer-readable instructions stored on a computer-usable medium for execution by a processor. Examples of computer-usable media include, but are not limited to, removable and non-removable magnetic media, optical media, dynamic random-access memory (DRAM), static random-access memory (SRAM), read-only memory (ROM) and electrically-erasable and programmable read-only memory (EEPROM or Flash). It is noted that computer-usable is also known as machine-usable. It also is noted that network devices can take multiple other physical forms, including, but not limited to, network devices that are functions of other network elements, or network devices that have functionality expressed in firmware or are hard-coded in a device such as an application-specific integrated circuit (ASIC) chip.

FIG. 1B is a simplified diagram of a network system with network devices. In FIG. 1B, several SNMP manageable network devices 122, a composite SNMP manageable network device 128, and RMON manageable network device 126 are coupled to a network 120 and are managed with a management facility 124. Each SNMP manageable network device 122 has an internal SNMP agent 130 that implements SNMP protocol and stores and retrieves management data requested by the management facility 124. The stored and retrieved management data is defined by the SNMP manageable network devices'122 internal MIB 132. Each SNMP manageable network device 122 in another embodiment optionally proxies for a non-SNMP manageable network device (not shown).

The RMON manageable device 126 has an internal RMON agent 134 that implements RMON protocol and stores and retrieves management data requested by the management facility 124. The stored and retrieved management data is defined by the RMON manageable network device's 126 one or more internal MIB(s) 136. RMON protocol defines in one embodiment nine MIBs that provide a much richer set of data about network usage than SNMP.

The composite SNMP manageable network device 128 has an internal SNMP agent 138 that implements SNMP protocol and stores and retrieves management data requested by the management facility 124. The stored and retrieved management data is defined by the composite SNMP manageable network device's 128 one or more internal MIBs 140. Composite SNMP manageable devices 128 are SNMP manageable network devices that consist of, or represent, multiple other network devices in a single SNMP manageable entity. It is noted that the other network devices that form or are represented by the composite network device 128 may themselves be SNMP manageable. Examples of composite SNMP manageable devices 128 include, but are not limited to, provisioning servers, configuration servers, modular chassis rack systems, or other network systems. As such, composite SNMP manageable devices 128 contain in various embodiments one or more internal MIBs 140 that represent each of the components or represented other network devices separately, or aggregate their separate MIBs into a single MIB 140 for the composite SNMP manageable device 128 that is presented to the management facility 124 by SNMP agent 138. An example of a provisioning server is described in the U.S. patent application Ser. No. (Attorney Docket No. 100.253US01) titled “Object Oriented Provisioning Server”, and the U.S. patent application Ser. No. (Attorney Docket No. 100.254US01) titled “Object Oriented Provisioning Server Object Model”, which are commonly assigned to the assignee of the present application and are incorporated herein by reference. An example of a modular chassis configuration server is described in the U.S. patent application Ser. No. (Attorney Docket No. 100.251US01) titled “Object Oriented Configuration Server”, and U.S. patent application Serial No. (Attorney Docket No. 100.252US01) titled “Configuration Server Object Model”, which are commonly assigned to the assignee of the present application and are also incorporated herein by reference.

The management facility 124 of a SNMP or RMON managed network 120 is implemented in one embodiment as a Network Management Station (NMS) in the SNMP or RMON “community”. Each management facility is able to query agents of network devices of a SNMP or RMON network, get responses from agents, set variables in agents, and acknowledge asynchronous events from agents

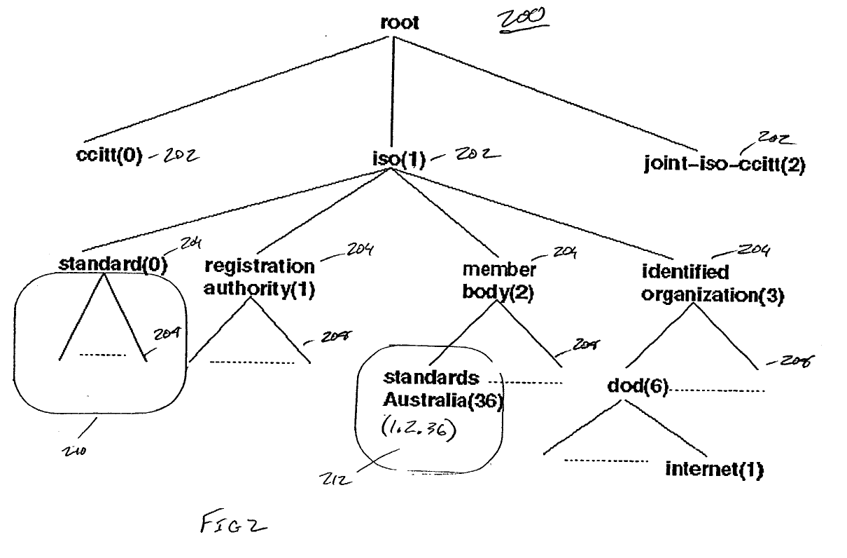

FIG. 2 is a simplified diagram of a SNMP MIB. The internal structure of a MIB 200 typically is that of a tree structured collection of definitions 202. Each definition 202 defines the properties of the objects within the network device. MIB object definitions or nodes 202 can have child object definitions or nodes 204, and those child object definitions 204 can have their own child object definitions 208, up to an arbitrary depth. All child object definitions are assigned a unique integer value within that sub-tree 210. If an object definition or node at any level has children then it is called an aggregate node. The object identifier (or name) of an object is the sequence of non-negative integer values, such as “1.2.36” 210, that traverse the MIB tree 200 to the object definition node required. The definition of a MIB tree 200 and allocation of integer values for a node in the tree is the responsibility of network standards bodies and the manufacturer of the network device. Each SNMP or RMON manageable network device keeps a database of values for each of the definitions written in the MIB.

In some embodiments, network devices of the present invention utilize an object oriented design (OOD) approach to implementation. In some embodiments of the present invention, elements of the system are represented in the network devices by objects in an object model. This allows for the network devices to be wholly implemented with object oriented programming (OOP) or partially implemented, with just the managed elements in an object model. This also allows instances of the “configuration” objects to be the configuration components that are affected by configuration change events with the added benefit of being capable of internalizing object methods and attributes to aid in operation of the network device embodiment of the present invention. Configuration objects in the present disclosure are defined as objects that contain attributes and methods to control the internal operation of the network device and keep record of its state. Configuration change events in the present disclosure are defined as any event that affects the state of the network device and includes, but is not limited to, a SNMP event, a RMON event, a configuration event from the graphic user interface (GUI), a configuration event from the command line interface (CLI). The configuration components contain all configuration information and necessary attributes and routines to manage the corresponding element of the network device that they represent or control.

As objects in an OOP approach can inherit characteristics from parent object classes that they were built from, network device embodiments of the present invention utilizing this technique allow for high amounts of code reuse in implementing other network device embodiments of the present invention. The code reuse and “objectization” of managed system elements in embodiments of the present invention eliminates much of the code development time and problems with errors as repeatable sections are reused and code is compartmentalized. For example, a change correcting an error in a single underlying class or extension of a class is reflected in all other classes that incorporate them. Additionally, the OOP approach with its inheritance characteristics allow for ease of extending network device embodiments of the present invention to managing new hardware, software, devices, or systems. In embodiments of the present invention building new classes, common elements are incorporated by inheritance from included object classes or a base object class and the object needs only to be extended to cover new functionality. Examples of object oriented languages that can allow for implementation of network device embodiments of the present invention include, but are not limited to, C++, Java, etc.

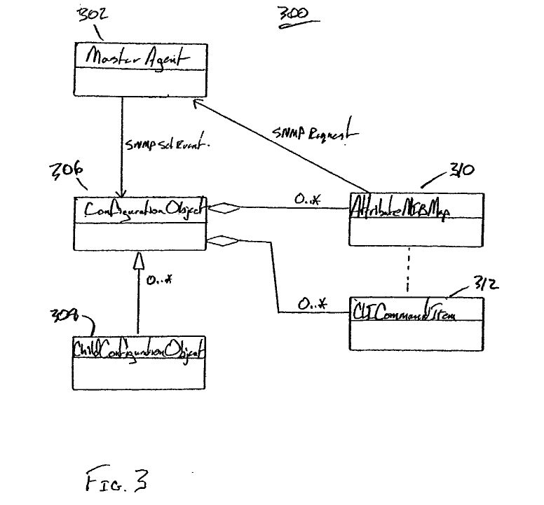

FIG. 3 is a simplified object model diagram showing an example of an object model 300 of an embodiment of the present invention. In FIG. 3, the object model 300 contains a master agent object 302, a base ConfigurationObject 306, derivative ChildConfigurationObjects 308, an AttributeMIBMap object 310, and a CLICommandltem object 312.

The ConfigurationObject 306 is the base object class for all ChildConfigurationObjects 308 utilized in the object model 300. The derivative ChildConfigurationObjects 308 extend the base ConfigurationObject 306 and further define and model the specific physical and logical components, and elements of the system.

In mapping a SNMP set notification to an object attribute pair, the MasterAgent 302 notifies the configuration object manager (COM, not shown) when a successful configuration event (SNMP set request) is processed. This allows the COM to update the object instances 306, 308 that represent of the state of elements of the network system. For each SNMP set notification, the COM receives a MIB name, instance, and value. The COM then updates the associated instance and attribute with the value. The update of an object instance due to a configuration event (SNMP set request) triggers rebuilding of the CLI command set for the modified object instance if necessary.

There are two available manners to map the SNMP set event received from the MasterAgent 302 to a configuration object instance and attribute. First, the SNMPSetEvent is passed from parent object to child object within the ConfigurationObject 306, 308 hierarchy, using the instance to route the SNMPSetEvent to the correct object 306, 308. Second, each object instance attribute registers interest for SNMPSetEvents with a notification service. When the notification service receives an SNMP event corresponding to a MIB name and instance matching a registered object instance, the notification service then notifies the attribute with matching MIB name and instance, gaining the efficiency of not having to pass the SNMPSetEvent from object to object within the ConfigurationObject 306, 308 hierarchy. As stated above, the notification service/mapping is handled in one embodiment by one or more objects of the AttributeMIBMap object class 310.

The AttributeMIBMap object class 310 aggregates attributes that map to a common MIB table. A representation of an internal AttributeMIBMap listing, with MIB name, instance, object reference, and attribute ID, is shown in Table 1. The AttributeMIBMap object class 310 in one embodiment contains a MIB table and provides methods for initialization of the object, computing the instance, and processing (data conversion) incoming and outgoing SNMP MIB name value pairs. The AttributeMIBMap object class 310 also contains methods to perform SNMP sets or gets. The AttributeMIBMap object class 310 contains values of the attribute name, MIB name, MIB type, default attribute value, current value, and last known value.

TABLE 1
Internal AttributeMIBMap listing

| | | | |
|---|---|---|---|
| MIB Name | Instance | Object | Attribute Id |
| | | Reference | |

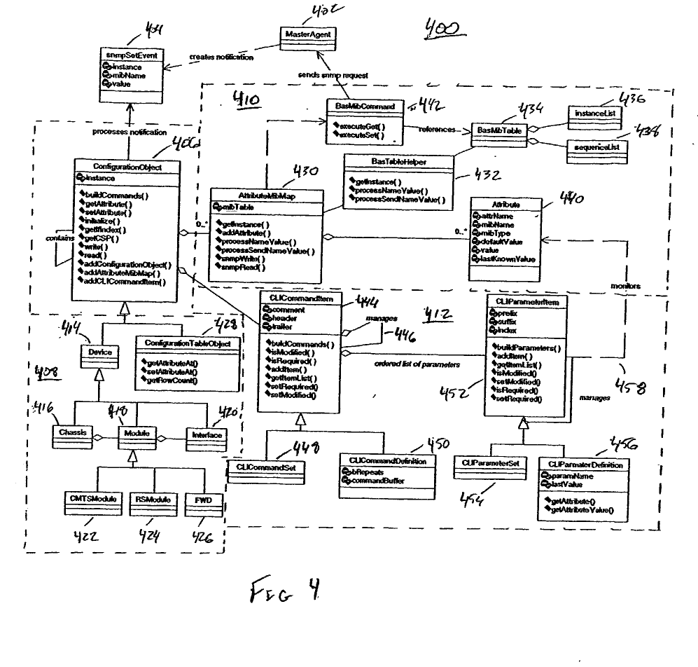

FIG. 4 is another simplified object model diagram showing additional detail of an example of an object model 400 of an embodiment of the present invention for a composite SNMP network device called a configuration server that manages a network system or modular network rack chassis in a representative fashion (i.e., the managed network elements or devices can contain their own SNMP agents and MIBs). In FIG. 4, the object model 400 contains a master agent object 402, an snmpSetEvent object 404, a base ConfigurationObject 406, a block of child configuration objects 408, a block of AttributeMIBMap objects 410, and a block of CLICommandItem objects 412.

The ConfigurationObject 406 is the base object class for all configuration objects 408 utilized in the object model 400. Configuration objects 408 model the physical and logical components of the system including the device 414, chassis 416, module 418, and interface 420. The chassis 416, module 418, and interface 420 objects extend the device object 414, which is itself an extension of the ConfigurationObject object 406. Each chassis object 416 can contain module 418 objects which in turn can contain interface 420 objects classes. The CMTSModule 422, RSModule 424, and FWD 420 are representative of classes that extend the module class 414 for specific module types that are in various embodiments inserted into the chassis and managed by the configuration server. Each class extension implements an initialization routine to instantiate any child objects. For example, the chassis object 416 instantiates instances for each module 418 in the chassis.

In the object model 400 of FIG. 4 two mappings are required to operate the configuration server and to handle requests. The first is to map a SNMP set notification to an object attribute pair, allowing incoming configuration change events to find and modify the appropriate object instance and attribute. This mapping is the job of the objects in the AttributeMIBMap object block 410. The second is to map one or more object instance attributes to a CLI command allowing the appropriate object instances and attributes to be utilized when a CLI command is used, and allowing for CLI command set generation by the configuration server and object model. This second mapping is the job of the objects in the CLUCommandltem object block 412.

In mapping a SNMP set notification to an object attribute pair, the MasterAgent 402 notifies the configuration object manager (COM, not shown) when a successful configuration event (a SNMP set request) is processed. This allows the COM to update the object instances 406, 408 that represent of the state of the chassis. For each SNMP set notification, the COM receives a MMB name, instance, and value. The COM then updates the associated instance and attribute with the value. The update of an object instance due to a configuration event (SNMP set request) triggers rebuilding of the CLI command set for the modified object instance.

There are two available manners to map the SNMP set event received from the MasterAgent 402 to an object instance and attribute. First, starting with the chassis, the SNMPSetEvent is passed from parent object to child object within the ConfigurationObject 406, 408 hierarchy, using the instance to route the SNMPSetEnvent to the correct object 406, 408. Second, each object instance attribute registers interest for SNMPSetEvents with a notification service. When the notification service receives an SNMP event corresponding to a MIB name and instance matching a registered object instance, the notification service then notifies the attribute with matching MIB name and instance, gaining the efficiency of not having to pass the SNMPSetEvent from object to object within the ConfigurationObject 406,408 hierarchy. The notification service/mapping is handled in one embodiment by the objects of the AttributeMIBMap object block 410.

The AttributeMIBMap object class 440 of the AttributeMIBMap object block 410 aggregates attributes that map to a common MIB table. The AttributeMIBMap object class 430 in one embodiment contains a MIB table and provides methods for initialization of the object, computing the instance, and processing (data conversion) incoming and outgoing SNMP MIB name value pairs. The AttributeMIBMap object class 430 also contains methods to perform SNMP sets or gets. The AttributeMIBMap object class 430 contains in one embodiment one or more of the Attribute objects 440 that contain values of the attribute name, MIB name, MIB type, default attribute value, current value, and last known value. This class 430 utilizes a BasTableHelper class 432 to interface with the BasMIBTable 434 that contains instanceList 436 and sequenceList 438 classes. Additionally the class uses the BasMMBCommand class 442 to execute gets and sets. The BasMIB classes are utilized for computing the instance, and processing incoming and outgoing name value pairs.

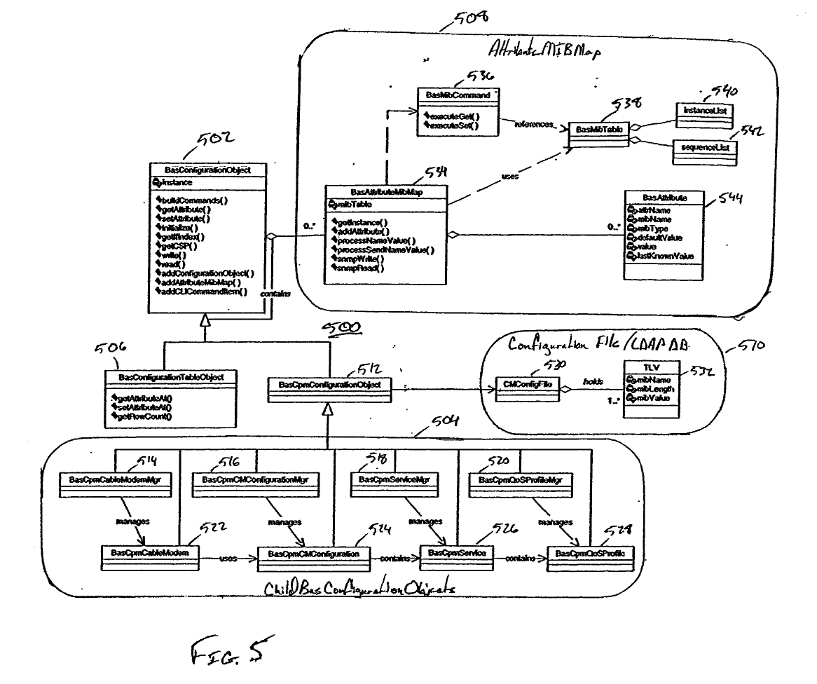

FIG. 5 is a simplified object model embodiment for a composite SNMP network device called a provisioning server that manages a network system. In FIG. 5, the object model 500 includes a base configuration object (BasConfigurationObject) 502, a block of child configuration objects (ChildBasConfigurationObjects) 504, a BasConfigurationTableObject 506, a block of AttributeMIBMap objects 508, and configuration files and lightweight data access protocol (LDAP) information database data conversion objects 510.

The BasConfigurationObject 502 is the base object class for all configuration objects 504 utilized in the object model 500. The ChildBasConfigurationObjects 504 model the specific physical and logical network elements of the system for the provisioning server and include BasCpmCableModemMgr object 514, BasCpmCableModem object 522, BasCpmCMConfigurationMgr object 516, BasCpmCMConfiguration object 524, BasCpmServiceMgr object 518, BasCpmService object 526, BasCpmQoSProfileMgr object 520, and BasCpmQoSProfile object 528. The ChildBasConfigurationObjects 504 extend the BasCpmConfigurationObject 512, which is itself an extension of the BasConfigurationObject object 502. Within the ChildBasConfigurationObjects 504, each manager object 514, 516, 518, and 520 manages its respective configuration object classes 522, 524, 526, and 528.

Each BasCpmCableModem object 522 uses a BasCpmCMConfiguration object 524 which contains in various embodiments BasCpmService objects 526 which in turn contains in various embodiments BasCpmQoSProfile object classes 528. The ChildBasConfigurationObjects 504 are representative of classes that extend the BasCpmConfigurationObject 512 and the BasConfigurationObject object 502 for specific network element types that are in various embodiments managed by the provisioning server.

Each class extension implements an initialization routine to instantiate any child objects. For example, the BasCpmCMConfiguration object 524 instantiates instances for each BasCpmService objects 526 associated with the network element. Each BasCpmConfigurationObject 512 and ChildBasConfigurationObject 504 communicates with objects of the configuration files and LDAP information database data conversion object block 510 to import and export configuration data to and from text configuration files, binary configuration files, and the LDAP information database. It is noted that because of the configuration files and LDAP information database data conversion object block 510 in the object model of FIG. 5 the import/export functionality of configuration data is external to the configuration objects for this embodiment.

In the object model 500 two mappings are used to operate the provisioning server and to handle requests. The first is to map a SNMP set notification to an object attribute pair, allowing incoming configuration change events to find and modify the appropriate object instance and attribute. This mapping is the job of the objects in the AttributeMIBMap object block 508. The second is to map one or more object instance attributes to a CLI command allowing the appropriate object instances and attributes to be utilized when a CLI command is used, and allowing for CLI command set generation by the provisioning server and object model. This second mapping is an aspect of the BasConfigurationObject 502 and its method addCLICommandltem( ).

In mapping a SNMP set notification to an object attribute pair, the MasterAgent (not shown) notifies the COM (not shown) when a successful configuration event (SNMP set request) is processed. This allows the COM to update the object instances 502, 512, 504 that represent of the state of the network. For each SNMP set notification, the COM receives a MIB name, instance, and value. The COM then updates the associated instance and attribute with the value. The update of an object instance due to a configuration event (SNMP set request) triggers rebuilding of the CLI command set for the modified object instance.

As stated above, there are two available manners to map the SNMP set event received from the MasterAgent to an object instance and attribute. First, the SNMPSetEvent is passed from parent object to child object within the BasConfigurationObject 502, 512, 504 hierarchy, using the instance to route the SNMPSetEvent to the correct object 502, 512, 504. Second, each object instance attribute registers interest for SNMPSetEvents with a notification service. When the notification service receives an SNMP event corresponding to a MIB name and instance matching a registered object instance, the notification service then notifies the attribute with matching MIB name and instance, gaining the efficiency of not having to pass the SNMPSetEvent from object to object within the BasConfigurationObject 502, 512, 504 hierarchy. The notification service/mapping is handled in one embodiment by the objects of the AttributeMIBMap object block 508.

The BasAttributeMIBMap object class 534 of the AttributeMIBMap object block 508 aggregates attributes that map to a common MIB table. The BasAttributeMIBMap object class 534 in one embodiment contains a MIB table and provides methods for initialization of the object, computing the instance, and processing (data conversion) incoming and outgoing SNMP MIB name value pairs. The BasAttributeMIBMap object class 534 also contains methods to perform SNMP sets or gets. The BasAttributeMIBMap object class 534 contains in one embodiment one or more of the BasAttribute objects 544 that contain values of the attribute name, MIB name, MIB type, default attribute value, current value, and last known value. The BasAttributeMIBMap object class 534 interfaces with the BasMIBTable 538 that contains instanceList 540 and sequenceList 542 classes to map MIB objects. Additionally, the BasAttributeMIBMap object class 534 uses the BasMIBCommand class 536 to execute gets and sets. The BasMIB classes of the AttributeMIBMap object block 508 are utilized for computing the instance, and processing incoming and outgoing name value pairs.

Alternative manners of mapping object attributes and methods to one or more MIBs of the present invention with object oriented programming techniques will be apparent to those skilled in the art with the benefit of the present disclosure, and are also within the scope of the present invention.

### CONCLUSION

A network device object model and method are described that allow for improved representation and management of an object oriented network device or network systems that are managed by SNMP or RMON and contain MIBs. The improved network device object model and method allow for efficient mapping of internal object instance attributes and methods of an object oriented network device or network system to a SNMP or RMON MIB(s). The improved network device object model and method also allow for efficient mapping and/or aggregation of internal object instance attributes and methods of a composite object oriented network device, such as a modular rack chassis or provisioning server. Additionally, the network device object model allows for efficient and reduced error implementations of MIBs for specific purpose network devices and ease of extension of the represented MIBs to additional network device application purposes and services.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An object model, comprising:
at least one first object, wherein the at least one first object is adapted to map at least one attribute or method of at least one second object to a management information base (MIB).

2. The object model of claim 1, wherein the at least one first object further comprises at least one child first object.

3. The object model of claim 1, wherein the at least one first object is adapted to aggregate the management information bases (MIBs) of other at least one first objects into its management information base (MIB).

4. The object model of claim 1, wherein the object model represents a simple network management protocol (SNMP) network device.

5. The object model of claim 1, wherein the object model represents a remote monitoring (RMON) network device.

6. The object model of claim 1, wherein the object model represents a composite simple network management protocol (SNMP) network device.

7. The object model of claim 6, wherein the at least one first object is adapted to map at least one attribute or method of at least one second object to a management information base (MIB) that represents the composite simple network management protocol (SNMP) network device.

8. The object model of claim 6, wherein the at least one first object is adapted to map at least one attribute or method of at least one second object to multiple management information bases (MIBs) that represent a simple network management protocol (SNMP) manageable element of the composite simple network management protocol (SNMP) network device.

9. A method of forming an object model for a network device, comprising:
representing device information, methods, and control values in at least one first object; and
mapping the represented device information, methods, and control values in the at least one first object to a management information base (MIB) with at least one second object.

10. The method of claim 9, wherein mapping the represented device information, methods, and control values to a management information base (MIB) further comprises mapping the represented device information, methods, and control values to a simple network management protocol (SNMP) management information base (MIB).

11. The method of claim 9, wherein mapping the represented device information, methods, and control values to a management information base (MIB) further comprises mapping the represented device information, methods, and control values to a remote monitoring (RMON) management information base (MIB).

12. The method of claim 9, wherein the at least one second object further comprises at least one second object with at least one other second object comprising a child object.

13. The method of claim 9, wherein the at least one second object is adapted to aggregate the management information bases (MIBs) of at least one other second object into its management information base (MIB).

14. The method of claim 9, wherein mapping the represented device information, methods, and control values to a management information base (MIB) further comprises mapping the represented device information, methods, and control values to a simple network management protocol (SNMP) management information base (MIB) that represents a composite simple network management protocol (SNMP) network device.

15. The method of claim 9, wherein mapping the represented device information, methods, and control values to a management information base (MIB) further comprises mapping the represented device information, methods, and control values to a plurality of simple network management protocol (SNMP) management information bases (MIBs) that each represent a simple network management protocol (SNMP) manageable element of a composite simple network management protocol (SNMP) network device.

16. A machine-usable medium having machine readable instructions stored thereon for execution by a processor to perform a method comprising:
acquiring network device information, methods, and control values; and
mapping the acquired device information, methods, and control values to a management information base (MIB) with at least one object.

17. The machine-usable medium of claim 16, wherein mapping the device information, methods, and control values to a management information base (MIB) further comprises mapping the acquired device information, methods, and control values to a simple network management protocol (SNMP) management information base (MIB).

18. The machine-usable medium of claim 16, wherein mapping the device information, methods, and control values to a management information base (MIB) further comprises mapping the acquired device information, methods, and control values to a remote monitoring (RMON) management information base (MIB).

19. The machine-usable medium of claim 16, wherein the at least one object further comprises at least one object with at least one other object that maps the acquired device information, methods, and control values to a management information base (MIB) as a child object.

20. The machine-usable medium of claim 16, wherein the at least one object is adapted to aggregate the management information bases (MIBs) of at least one other object that maps the acquired device information, methods, and control values to a management information base (MIB) into its management information base (MIB).

21. The machine-usable medium of claim 16, wherein mapping the represented device information, methods, and control values to a management information base (MIB) further comprises mapping the represented device information, methods, and control values to a simple network management protocol (SNMP) management information base (MIB) that represents a composite simple network management protocol (SNMP) network device.

22. The machine-usable medium of claim 16, wherein mapping the represented device information, methods, and control values to a management information base (MIB) further comprises mapping the represented device information, methods, and control values to a plurality of simple network management protocol (SNMP) management information bases (MIBs) that each represent a simple network management protocol (SNMP) manageable element of a composite simple network management protocol (SNMP) network device.

23. A network device comprising:
a memory;
a network interface;
a processor coupled to the memory and the network interface; and
an object model, the object model comprising:
at least one first object; and
one or more second objects, where the at least one first object is adapted to map at least one attribute or method of the one or more second objects to a management information base (MIB).

24. The network device of claim 23, wherein the network device is manageable with simple network management protocol (SNMP).

25. The network device of claim 23, wherein the network device is manageable with remote monitoring (RMON).

26. The network device of claim 23, wherein the network device is a composite simple network management protocol (SNMP) network device.

27. The network device of claim 26, wherein the composite simple network management protocol (SNMP) network device is a configuration server.

28. The network device of claim 26, wherein the composite simple network management protocol (SNMP) network device is a provisioning server.

29. The network device of claim 26, wherein the composite simple network management protocol (SNMP) network device is a representative simple network management protocol (SNMP) network device that represents and manages other simple network management protocol (SNMP) network devices on the network.

30. The network device of claim 26, wherein the composite simple network management protocol (SNMP) network device consists of other simple network management protocol (SNMP) manageable elements.

31. The network device of claim 26, wherein the composite simple network management protocol (SNMP) network device represents other simple network management protocol (SNMP) manageable elements with separate management information bases (MIBs).

32. The network device of claim 26, wherein the composite simple network management protocol (SNMP) network device represents other simple network management protocol (SNMP) manageable elements with a single management information base (MIB).

33. The network device of claim 24, wherein the simple network management protocol (SNMP) network device proxies for at least one other manageable network device.

34. The network device of claim 23, wherein the network device is implemented in an object oriented programming language.

35. The network device of claim 23, wherein the network device is partially implemented in an object oriented programming language.

36. An object model for a network device, comprising:
a first set of objects, the first set of objects adapted to contain configuration information, methods, and data for the network device; and
a second set of objects, wherein the second set of objects is adapted to represent the configuration information, methods, and data of the first set of objects in one or more management information base (MIB)s.

37. In a network device having a memory, a network interface, a computer-usable medium for storing computer readable instructions, and a processor coupled to the memory, the computer-usable medium, and a network interface, an object model, comprising:
a first set of objects, the first set of objects adapted to contain configuration information, methods, and data for the network device; and
a second set of objects, wherein the second set of objects is adapted to represent the configuration information, methods, and data of the first set of objects in one or more management information base (MIB)s.

38. The network device of claim 37, wherein the network device has a simple network management protocol (SNMP) interface.

39. The network device of claim 37, wherein the network device has a remote monitoring (RMON) interface.

40. A network device comprising:
a memory;
a network interface;
a processor coupled to the memory and the network interface;
a management information base (MIB); and
an object model, the object model comprising:
at least one first object; and
at least one second object, where the at least one first object is adapted to map at least one attribute or method of the at least one second object to the management information base (MIB).
